(19) United States
(12) Patent Application Publication
(10) Pub. No.: US 2012/0328504 A1
(43) Pub. Date: Dec. 27, 2012

(54) METHOD FOR PREPARING A SOLUTION INCLUDING MONOCHLORAMINE

(75) Inventor: Catherine Debiemme-Chouvy, Saint Maur Des Fosses (FR)

(73) Assignee: CENTRE NATIONAL DE LA RECHERCHE SCIENTIFIQUE (C.N.R.S), Paris (FR)

(21) Appl. No.: 13/510,244

(22) PCT Filed: Nov. 15, 2010
(86) PCT No.: PCT/FR10/52421

§ 371 Date: Sep. 11, 2012

(30) Foreign Application Priority Data
Nov. 16, 2009 (FR) 0958063

(51) Int. Cl. C01B 21/09

(52) U.S. Cl. 423/413

(57) ABSTRACT

A method for preparing a solution including monochloramine includes the steps of: a) in an electrolyzer including an anode area and a cathode area separated by a membrane limiting the migration of hypochlorite ions, forming hypochlorite ions in the anode area by means of the oxidation of chloride ions in an aqueous solution, and forming ammonium ions in the cathode area by means of the reduction of nitrate and/or nitrite ions in an aqueous solution; and b) reacting the ammonium ions with at least one portion of the hypochlorite ions, with a molar ratio of hypochlorite ions to ammonium ions no lower than 1, resulting in the formation of monochloramine.

The present invention relates to a method for preparing an aqueous solution comprising monochloramine, and, according to certain embodiments, hypochlorite ions, in particular useful as disinfectant solution.

A disinfection is said to be primary if it makes it possible to destroy the microorganisms, and secondary if it makes it possible to avoid recontamination. Hypochlorite ions are a primary disinfectant, and monochloramine is a secondary disinfectant.

The literature reports the synthesis of monochloramine by reaction of hypochlorite ions with ammonium ions.

US patent application 2004/00866577 reports a method for preparing monochloramine comprising the steps of basifying a solution of sodium hypochlorite with an inorganic base, then reacting the basified sodium hypochlorite with a solution of ammonium chloride. This method has the drawback of involving handling toxic bleach and ammonia solutions.

Furthermore, international application WO2008/091678 describes a method for preparing a haloamine biocide preparation comprising the following steps:

a) charging an electrochemical cell with a solution comprising a halide,
b) electrochemically generating an active halogen donor species,
c) putting that active species in contact with a solution comprising an amine.
Example 1 describes the synthesis of monochloramine by mixing an aqueous ammonia solution with hypochlorite ions obtained by oxidation of the chloride ions of a sodium chloride solution. This method does, however, have the drawback of manipulating a toxic ammonia solution.

Furthermore, various hypochlorite ion synthesis methods are known from the prior art. For example, the companies Oxilite® and Avipur® market the Oximat® device, which makes it possible to prepare hypochlorite ions by oxidation of chloride ions from a starting solution comprising sodium chloride. Likewise, the OXIPRO® water disinfection system implements an oxidation of chloride ions into hypochlorite ions.

One aim of the present invention is to provide a method for preparing a solution comprising monochloramine, which can in particular overcome the aforementioned drawbacks.

To that end, according to a first aspect, the invention relates to a method for preparing a solution comprising monochloramine, comprising the steps of:

a) in an electrolyzer comprising an anodic area and a cathodic area separated by a membrane limiting the migration of hypochlorite ions:

forming hypochlorite ions in the anodic area by oxidation of chloride ions in an aqueous solution, and

forming ammonium ions in the cathodic area by reduction of nitrate and/or nitrite ions in an aqueous solution, and

b) reacting the ammonium ions with at least one portion of the hypochlorite ions, with a molar ratio of hypochlorite ions to ammonium ions higher than or equal to 1, whereby monochloramine is formed.

The method according to the invention uses chloride ions and nitrate and/or nitrite ions as starting products, which have the advantage of being inexpensive.

The reactions carried out in this method are the following:

During step a), at the anode:

2 Cl⁻→Cl₂+2 e⁻then Cl₂+H₂O→ClO⁻+Cl⁻+2 H⁺

and at the cathode:

NO₃⁻+6 H₂O+8 e⁻→NH₃+9 OH⁻

and/or

NO₂⁻+5 H₂O+6 e⁻→NH₃+7 OH⁻.

During step b):

ClO⁻+NH₄⁺→NH₂Cl+H₂O.

The two electrochemical reactions of step a), i.e. on the one hand the oxidation of chloride ions to form the hypochlorite ions and on the other hand the reduction of nitrate and/or nitrite ions to form ammonium ions, take place in two separate areas of an electrolyzer, i.e.:

the anodic area, which is the area comprising an anode and the electrolyte close to the anode, i.e. the anolyte, and in which the oxidation of the chloride ions takes place,

the cathodic area, which is the area comprising a cathode and the electrolyte close to the cathode, i.e. the catholyte, and in which the reduction of the nitrate and/or nitrite ions takes place.

Typically, the anodic area comprises an anode capable of oxidizing the chloride ions before oxidizing the water. The anode can in particular be a dimensionally stable anode, or “DSA” (Trasatti, Electrochimica Acta, 45, 2377-2385, 2000). For example, anodes made up of antimony doped tin oxide or boron doped diamond (BDD) can be used.

The cathodic area comprises a cathode, which can in particular be a copper or palladium-copper electrode.

The specific surfaces of the anodes and cathodes implemented in the method can vary widely and are adapted as a function of the geometry of the electrolyzer and the chloride or nitrate/nitrite concentrations of the solutions.

The electrolysis can be carried out using any means known by those skilled in the art, in particular by applying a potential difference between the anode and the cathode, by adding a reference electrode in order to impose the potential of the anode or cathode, or in galvanostatic mode.

The two anodic and cathodic areas of the electrolyzer are separated by a membrane making it possible to minimize or even prevent the migration of the hypochlorite ions toward the cathode, which would lead to their reduction into chloride ions.

In one embodiment, the membrane is a sintered glass membrane or a cationic membrane, preferably a Nafion membrane.

In this application, “hypochlorite ions” means that the hypochlorite ions can be completely in basic form or partially or completely in their acid form: hypochlorous acid. Likewise, “ammonium ion” means that the ammonium ions can be completely in acid form or partially or completely in their basic form: ammonia.

The aqueous solution comprising chloride ions that is used in step a) is preferably an aqueous solution of potassium chloride, sodium chloride. An aqueous solution saturated with sodium chloride can in particular be used.

The aqueous solution comprising nitrate and/or nitrite ions that is used in step a) is preferably an aqueous solution of potassium nitrate and/or nitrite, sodium nitrate and/or nitrite.

In one embodiment, the solution introduced into the cathodic area also comprises a salt, for example potassium perchlorate, which makes the solution more conductive and minimizes the ohmic drop.

In one embodiment, during step a), a same aqueous solution is introduced comprising chloride and nitrate ions and/or in the anodic and cathodic areas. This embodiment has the advantage of having only one starting solution to be prepared.

In step b), the hypochlorite ions are reacted with the ammonium ions formed in step a) with a molar ratio of hypochlorite ions to ammonium ions higher than or equal to 1, the pH of the medium being higher than 7, which makes it possible to form the monochloramine through the following reaction ClO⁻+NH₄⁺→NH₂Cl+H₂O while consuming substantially all of the ammonium ions. The solution obtained using the method is therefore substantially free of ammonium ions (or ammonia).

It is desirable for the pH of the medium during step b) to be higher than 7, in particular to avoid the formation of dichloramine or even trichloramine. To that end, it is typical for one skilled in the art to adapt the pH of the medium, for example by adding a base (e.g. sodium hydroxide) or an acid (e.g. hydrochloric acid), if necessary.

Typically, at the end of step b), the pH of the medium is between 7.5 and 9.25, in particular between 8 and 9. Thus, step b) is typically carried out under conditions such that the majority of the hypochlorite ions are in their basic form and the majority of the ammonium ions are in their acid form, so as to optimize the reaction between the hypochlorite and ammonium ions to form the monochloramine. Preferably, the pH of the medium at the end of step b) is around 8.4. The pKa of the hypochlorous acid/hypochlorite ion pair is indeed 7.5, and that of the ammonia/ammonium ion pair is 9.25.

In one specific embodiment, the molar ratio of hypochlorite ions to ammonium ions in step b) is equal to 1. In that case, all of the hypochlorite ions used in step b) react with the ammonium ions to form monochloramine in step b). The solution obtained at the end of step b) then comprises monochloramine and is substantially or even completely free of hypochlorite ions.

In another embodiment, during step b), the molar ratio of hypochlorite ions to ammonium ions is higher than 1. In that case, only a portion of the hypochlorite ions used in step b) reacts with the ammonium ions to form monochloramine during step b). The solution obtained at the end of step b) then comprises monochloramine and hypochlorite ions. This embodiment is particularly advantageous, as the solution obtained at the end of step b) comprises both a primary disinfectant (hypochlorite ions) and a secondary disinfectant (monochloramine). In that context, the method according to the invention makes it possible to obtain a solution comprising two types of disinfectants simply and quickly from inexpensive salts.

Any adapted method can be used to place the hypochlorite ions in contact with the ammonium ions so as to produce the reaction of step b).

In a first embodiment, step b) is done by mixing hypochlorite ions and ammonium ions in an area outside the cathodic and anodic areas.

“Outside area” refers to an area that is neither the anodic area nor the cathodic area. Typically, the solutions respectively leaving the cathodic and anodic areas are mixed in a container outside the electrolyzer.

The reaction of step b) can then be done by batch or continuously.

The batch method makes it possible to store the intermediate solutions (solution comprising the hypochlorite ions on the one hand and solution comprising the ammonium ions on the other hand) and to measure their concentrations of hypochlorite or ammonium ions and their pH before mixing. It is then possible to carry out step a) from solutions with any concentrations of chloride and/or nitrate/nitrite, then to adapt the quantities of solutions to be mixed and/or their pH to perform step b).

The continuous method consists of putting a continuous flow leaving the cathodic area in contact with a continuous flow leaving the anodic area in the outside area. In this embodiment, the quantity of chloride ions in the solution entering the anodic area before electrolysis and the quantity of nitrate/nitrite ions in the solution entering the cathodic area before electrolysis are adapted so that the molar ratio of hypochlorite ions to ammonium ions is higher than or equal to 1 during step b).

In a second embodiment, the reaction of step b) is done within the anodic area.

Typically, at least a portion (and generally all) of the ammonium ions formed in the cathodic area during step a) is injected into the anodic area. This embodiment is generally done continuously. Generally, the flow leaving the catholyte is injected into the anodic area.

This continuous embodiment can in particular use a circulation of an aqueous solution initially comprising nitrate and/or nitrite ions, which is first introduced into the cathodic area (where the reduction of the nitrate and/or nitrite ions into ammonium ions takes place), then brought into the anodic area (where the ammonium ions react with the hypochlorite ions to form the monochloramine), which results directly in a disinfecting solution ready to be used at the outlet of the anodic area.

Two embodiments can in particular be considered when the method is done continuously.

In one embodiment i), the solution introduced into the cathodic area comprises nitrate and/or nitrite ions and chloride ions, and only the solution coming from the cathodic area (comprising chloride and ammonium ions) is introduced into the anodic area. There is then only a single flow entering the anodic area, i.e. the flow leaving the cathodic area (comprising ammonium and chloride ions). In the anodic area, the introduced chloride ions are oxidized into hypochlorite ions and react with the ammonium ions to form the monochloramine. Preferably, at the beginning of the method, an aqueous solution comprising chloride ions is introduced into the anodic area, which leads to the formation of hypochlorous ions, which are present in the anodic area when the flow leaving the cathodic area is injected. Then, when the method continues, the chloride ions coming from the cathodic area are oxidized into hypochlorite ions in the anodic area. There are therefore hypochlorite ions present in the anodic area that react in the anodic area with the ammonium ions coming from the cathodic area.

In another embodiment ii), a solution comprising chloride ions is continuously introduced into the anodic area jointly with the introduction of the flow leaving the cathodic area. There are then two flows jointly entering the anodic area, i.e. a first flow, called “flow 1,” leaving the cathodic area (comprising ammonium ions), and a second flow, called “flow 2,” that of the solution comprising chloride ions. The chloride ions are oxidized into hypochlorite ions, which react partially or completely with the ammonium ions coming from the cathodic area.

In one particular embodiment of embodiment ii), a same solution comprising nitrate and/or nitrite ions and chloride ions is injected both into the cathodic area and the anodic area. In the cathodic area, the nitrate and/or nitrite ions are reduced into ammonium ions, and the chloride ions do not react. The flow leaving the cathodic area therefore comprises chloride and ammonium ions. On the one hand, this flow leaving the cathodic area, comprising chloride and ammonium ions (flow 1), and on the other hand, the solution comprising nitrate and/or nitrite ions and chloride ions (flow 2), are introduced into the anodic area. In this way, the ammonium ions react in the anodic area with hypochlorite ions to form monochloramine (step b). Furthermore, the chloride ions (coming from the cathodic area) are oxidized into hypochlorite ions (oxidation of step a)), which advantageously makes it possible to reduce the chloride ion content of the obtained disinfecting solution. This limitation of the chloride ion content advantageously makes it possible to limit corrosion problems, for example the exit behavior from the device when the latter is metal, or during applications of the disinfecting solution if metal materials are used. This embodiment therefore has the advantage of making it possible to introduce a same solution comprising nitrate and/or nitrite ions and chloride ions into the cathodic area and the anodic area at the same time, and of limiting corrosion problems. However, this embodiment has the drawback of providing an exit solution comprising nitrate ions (the nitrate ions introduced into the anodic area are not transformed), and it is therefore preferable to implement the other aforementioned embodiments when a nitrate ion-depleted solution is desired.

According to a second aspect, the invention relates to a method as mentioned above for preparing a disinfecting solution.

This disinfecting solution has many uses, in particular for the treatment and prevention of microbial contaminations or the development of a biofilm. It can also be used to disinfect water or air, for example by fogging the solution in the air to be disinfected.

When a disinfection application is considered for potable water, it is preferable to adjust the nitrate ion concentration of the aqueous solution comprising nitrate ions used in the aforementioned step a), so that the nitrate ion concentration in the potable water treated with the solution obtained by the method is less than 8.10⁻⁴ M, or 50 mg L⁻¹.

The examples and figures below illustrate the method according to the invention.

### FIGURES

FIGS. 1 and 2 show the light absorbance as a function of the wavelength in nm of the disinfecting solutions respectively obtained in examples 1 and 2, to which Monochlor F (HACH) has been added to detect the presence of monochloramine.

### EXAMPLES

### Example 1: Method in Which the Anode is the Working Electrode, Reference Electrode: Saturated Calomel Electrode (SCE)

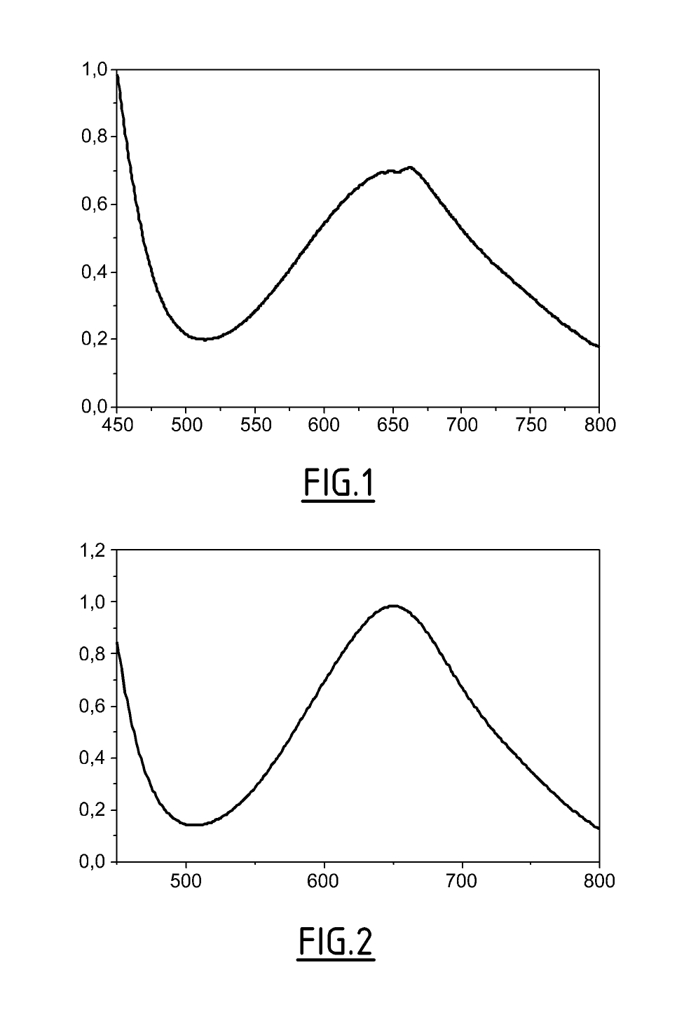

30 mL of an aqueous solution of potassium chloride (0.5 M) was introduced into the anodic area and 10 mL of an aqueous solution of potassium nitrate (0.01 M) and potassium perchlorate (0.5 M) was introduced into the cathodic area. Electrolysis was done at 1.65 V/SCE with a charge of 2.05 C and with an anode made up of antimony doped tin oxide with a surface of 2 cm² (working electrode) and a copper cathode with a surface of 0.3 cm² (counter electrode). Then, 6 mL of the anolyte and 4 mL of the catholyte were withdrawn and mixed to form the monochloramine, the presence of which was detected by adding a specific reagent, i.e. Monochlor F® (Hach®), which causes a green color when it is placed in the presence of monochloramine. FIG. 1 shows the absorbance of the obtained solution as a function of the wavelength and demonstrates that the green color was indeed observed.

### Example 2: Method in Which the Cathode is the Working Electrode

30 mL of an aqueous solution of potassium chloride (0.5 M) was introduced into the anodic area and 10 mL of an aqueous solution of potassium nitrate (0.01 M) and potassium perchlorate (0.5 M) was introduced into the cathodic area. Electrolysis was done at −1.4 V/SCE with a charge of 4.6 C and with an anode made up of antimony doped tin oxide with a surface of 2 cm² (counter electrode) and a copper cathode with a surface of 0.8 cm² (working electrode). Then, 3 mL of the anolyte and 8 mL of the catholyte were withdrawn and mixed to form the monochloramine, the presence of which was detected by adding a specific reagent, i.e. Monochlor F® (Hach®), which causes a green color when it is placed in the presence of monochloramine. FIG. 2 shows the absorbance of the obtained solution as a function of the wavelength and demonstrates that the green color was indeed observed.

1. A method for preparing a solution comprising monochloramine, comprising the steps of:
a) providing an electrolyzer comprising an anodic area and a cathodic area separated by a membrane limiting the migration of hypochlorite ion;
b) forming hypochlorite ions in the anodic area by oxidation of chloride ions in an aqueous solution,
c) forming ammonium ions in the cathodic area by reduction of nitrate and/or nitrite ions in an aqueous solution, and
D) reacting the ammonium ions with at least one portion of the hypochlorite ions, with a molar ratio of hypochlorite ions to ammonium ions higher than or equal to 1, the pH of the medium being higher than 7, whereby monochloramine is formed.

2. The method for preparing a solution comprising monochloramine according to claim 1, wherein, during step b), the hypochlorite ions are reacted with the ammonium ions formed in step a) with a molar ratio of hypochlorite ions to ammonium ions equal to 1.

3. The method for preparing a solution comprising monochloramine and hypochlorite ions according to claim 1, wherein, during step b), the hypochlorite ions are reacted with the ammonium ions formed in step a) with a molar ratio of hypochlorite ions to ammonium ions higher than 1.

4. The preparation method according to claim 1, wherein, during step a), a same aqueous solution comprising chloride ions and nitrate and/or nitrite ions is introduced into the anodic and cathodic areas.

5. The preparation method according to claim 1, wherein step b) is carried out by mixing hypochlorite ions and ammonium ions in an area outside the cathodic and anodic areas.

6. The preparation method according to claim 1, wherein the reaction of step b) is done within the anodic area.

7. The preparation method according to claim 1, wherein, at the end of step b), the pH of the medium is comprised between 7.5 and 9.25.

8. The preparation method according to claim 1, wherein the anodic area comprises an anode capable of oxidizing the chloride ions before oxidizing the water.

9. The preparation method according to claim 1, wherein the cathodic area comprises a copper or palladium-copper cathode.

10. The preparation method according to claim 1, wherein the membrane is a sintered glass membrane or a cationic membrane.

11. The preparation method according to claim 1, wherein a reference electrode is added to the electrolyzer during step a) so as to impose the potential of the anode or the cathode.

12. The method according to claim 1 for preparing a disinfecting solution.

13. The preparation method according to claim 1, wherein, at the end of step b), the pH of the medium is comprised between 8 and 9.

14. The preparation method according to claim 8, wherein the anodic area comprises a dimensionally stable anode.

15. The preparation method according to claim 8, wherein the anodic area comprises an anode made up of antimony doped tin oxide or boron doped diamond.

16. The preparation method according claim 10, wherein the membrane is a Nafion membrane.
